(19) United States
(12) Patent Application Publication
(10) Pub. No.: US 2014/0323280 A1
(43) Pub. Date: Oct. 30, 2014

(54) CNC MACHINE TOOL WITH A SINGLE-SPINDLE AND TWO SETS OF CUTTING TOOL CHANGERS

(71) Applicant: Feng-Tien Chen, Taichung City (TW)

(72) Inventor: Feng-Tien Chen, Taichung City (TW)

(21) Appl. No.: 13/944,862

(22) Filed: Jul. 17, 2013

(30) Foreign Application Priority Data
Apr. 29, 2013 (TW) 102207866

(51) Int. Cl. B23Q 3/157

(52) U.S. Cl. CPC B23Q 3/15713
USPC 483/37

(57) ABSTRACT

A CNC machine tool with a single-spindle and two sets of cutting tool changers, includes a machine unit, a first cutting tool changer, and a second cutting tool changer, wherein the machine unit comprises a machine body, a processing spindle head, a working table, a spindle, and cutting tools. The first cutting tool changer comprises a first cutting tool magazine arranged on one side of the machine body, a first cam driving mechanism, and a first cutting tool exchanging arm, wherein the first cutting tool exchanging arm is able to exchange the cutting tools respectively located within the first cutting magazine and located on the spindle. The second cutting tool changer has the same structure and function as the first cutting tool changer. Therefore, it is able to manage a huge number of cutting tools so as to apply to long-term and non-stop cutting process and improve the production efficiency.

### NOTICE OF COPYRIGHT

A portion of the disclosure of this patent document contains material that is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a CNC machine tool, and more particularly to a CNC machine tool with a single-spindle and two sets of cutting tool magazines so as to significantly improve production efficiency.

2. Description of Related Arts

As shown in FIG. 1, a conventional CNC machine tool 1 comprises a machine unit 10 and a cutting tool changer 20, wherein the machine unit 10 comprises a machine body 11, a processing spindle head 12 slidingly arranged on the machine body 11 for moving up and down, a saddle 13 slidingly arranged at the machine body 11 for moving back and forth, a working table 14 slidingly arranged on the saddle 13 for moving right and left, and a rotatable spindle 121 attached under the processing spindle head 12 and provided to install a cutting tool 100, wherein, the working table 14 is able to support a workpiece. In addition, while the spindle 121 is rotating, the cutting tool 100 can be driven to rotate. Furthermore, the conventional machine tool is controlled by the computer control system based on the user instructions. The movement of the processing spindle head 12, the saddle 13, and the working table 14 will be activated by the user instructions, wherein the working table 14 moves closely to the processing spindle head 12, so that the cutting tool is provided to cut the workpiece. In addition, when different kinds of cutting tools 100 are needed throughout the cutting process, the cutting tool changer 20 is enabled to exchange the cutting tool 100 from the spindle 121. The cutting tool changer 20 comprises a cutting tool magazine 21 arranged at one side of the machine body 11, a cam driving mechanism 22 arranged between the cutting tool magazine 21 and the processing spindle head 12, a cutting tool exchanging arm 23 arranged on the cam driving mechanism 22, and cutting tool holders 231 arranged on the two ends of the cutting tool exchanging arm 23, wherein multiple types and sizes of cutting tools 100 are circularly arranged inside the cutting tool magazine 21, and wherein the cutting tool exchanging arm 23 is activated to move up and down and in a revolving motion by the cam driving mechanism 22. While the cutting tool changer 20 is executing the exchange of the cutting tool 100, the cutting tools 100 selected by the user instructions moves downwardly to the bottom exit of the cutting tool magazine 21, and then the cutting tool exchanging arm 23 is activated to revolve by the cam driving mechanism 22 so that the cutting tools 100 placed on the spindle 121 and placed at the bottom exit of the cutting tool magazine 21 are respectively gripped by the cutting tool exchanging arm 23. Then, the cutting tool exchanging arm 23 is activated to rotate 180 degrees by the cam driving mechanism 22 so that the respective positions of the cutting tools 100 arranged on the spindle 121 and on cutting tool magazine 100 are exchanged so as to complete the cutting tool exchanging motion.

According to the above-mentioned conventional machine tool 1, it is able to exchange the cutting tool 100 depending on the demand for the work piece of the cutting process. However, there are several drawbacks to the use of the conventional machine tool 1. On one hand, the conventional machine tool comprises a single-spindle 121 and a cutting tool changer 20, wherein the cutting tool changer 20 comprises a cutting tool magazine 21 adopted for storing all cutting tools 100 that are used throughout the cutting process. However, the internal capacity of the cutting tool magazine 21 is usually not enough to store all cutting tools 100 used throughout the cutting process. When the workpiece is to be cut into a complex-shape, a large number of cutting tools 100 are required to support the cutting process. Therefore, the amount of the cutting tools 100 in one cutting tool magazine 21 is often insufficient for dealing with the cutting process for the complex-shaped workpiece. On the other hand, when the conventional machine tool is involved in mass production, the conventional machine tool is operated non-stop, for twenty-four hours. Thereby, the cutting tools 100 inevitably wear and damage under this steady operation, so the precision of the cutting process is likely to decrease. At this point, the cutting tool 100 needs to be replaced. It is known that the conventional machine tool comprises only one cutting tool magazine 21, so the cutting tool magazine 21 needs to keep working throughout the cutting process. Therefore, when a user wants to replace one of the cutting tools 100 within the cutting tool magazine 21, the user's only option is to stop the conventional machine tool 1. This decreases and deteriorates the efficiency of the cutting process.

In order to solve the drawbacks of the conventional machine tool, it is highly desirable to develop a CNC machine tool with a single-spindle and two sets of cutting tool changers so as to enhance the efficiency throughout entire cutting process.

### SUMMARY OF THE PRESENT INVENTION

A main object of the present invention is to provide a CNC machine tool with a single-spindle and two sets of cutting tool changers so as to significantly improve production efficiency

Accordingly, in order to achieve the above object, the present invention provides a CNC machine tool with a single-spindle and two sets of cutting tool changers, comprised of a machine unit, a first cutting tool changer, and a second cutting tool changer, wherein the machine unit comprises a machine body, a processing spindle head movable provided on the machine body, a working table movably arranged on the machine body, a spindle attached under the processing spindle head and adapted to allow for the installation of a cutting tool. The first cutting tool changer comprises a first cutting tool magazine arranged at one side of the machine body adapted for storing large amount of cutting tools, a first cam driving mechanism arranged between the first cutting tool magazine and the processing spindle head, and a first cutting tool exchanging arm movably arranged on the first cam driving mechanism. Therefore, the first cutting tool exchanging arm is activated to exchange the cutting tools that are respectively located within the first cutting magazine and on the spindle by the first cam driving mechanism.

The second cutting tool changer comprises a second cutting tool magazine arranged on the other side of the machine body adapted for storing a large amount of cutting tools, a second cam driving mechanism arranged between the second cutting tool magazine and the processing spindle head, and a second cutting tool exchanging arm movably arranged on the second cam driving mechanism. Therefore, the second cutting tool exchanging arm is activated to exchange the cutting tools that are respectively located within the second cutting magazine and on the spindle by the second cam driving mechanism.

The CNC machine tool with a single-spindle and two sets of cutting tool changers according to the present invention can achieve the following advantage:

The single-spindle arranged on the processing spindle head has two sets of cutting tool changers that can be interchangeably used with each other. Thereby, it is not only able to manage a huge number and multiple styles of cutting tools so as to satisfy dealing with the cutting process for the complex-shaped workpiece, but also applicable to lengthy and non-stop cutting processes so as to improve production efficiency.

### BRIEF DESCRIPTION OF THE DRAWINGS

FIG. 1 is a schematic view of a conventional CNC machine tool.

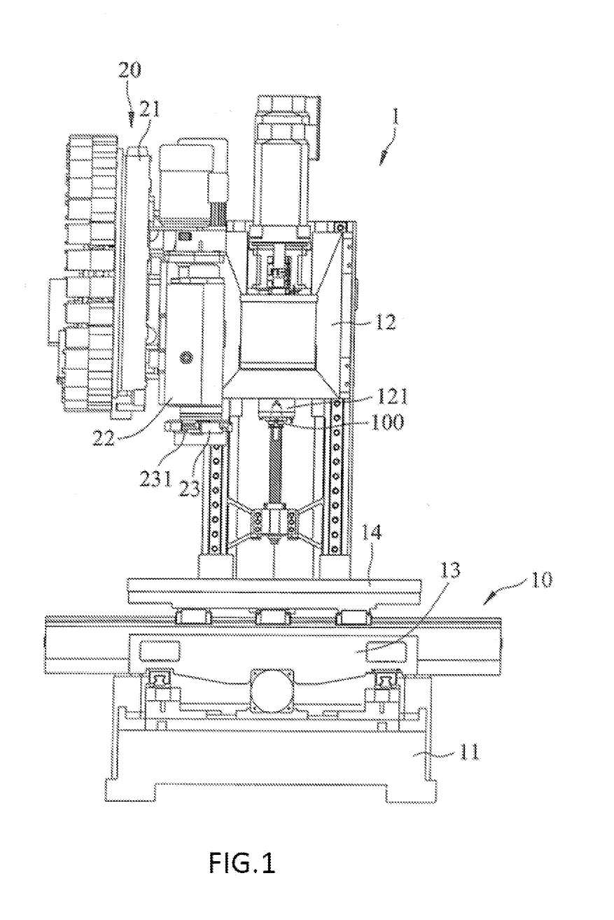

FIG. 2 is a schematic view of a CNC machine tool with a single-spindle and two sets of cutting tool changers according to a preferred embodiment of the present invention.

FIG. 3 is a left perspective view of the CNC machine tool with a single-spindle and two sets of cutting tool changers as shown in FIG. 2 according to the preferred embodiment of the present invention.

FIG. 4 is a perspective view of the CNC machine tool with a single-spindle and two sets of cutting tool magazines that utilizes a first cutting tool changer to exchange cutting tools.

FIG. 5 is a perspective view of the CNC machine tool with a single-spindle and two sets of cutting tool magazines that utilizes a second cutting tool changer to exchange cutting tools.

### DETAILED DESCRIPTION OF THE PREFERRED EMBODIMENT

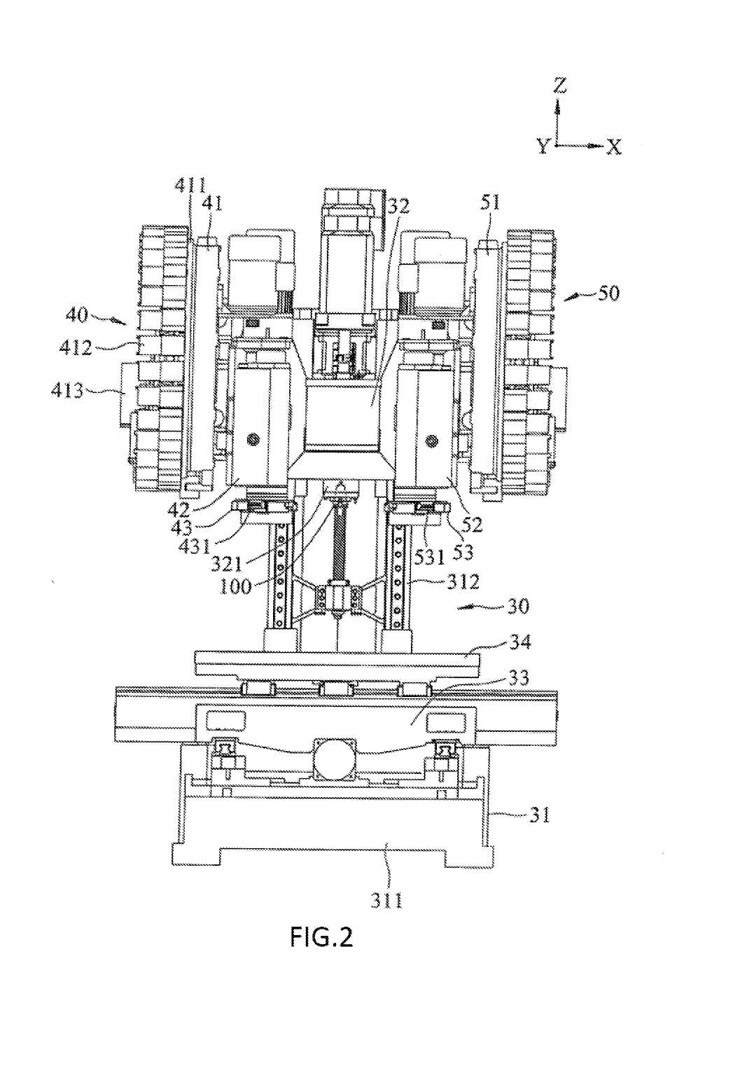

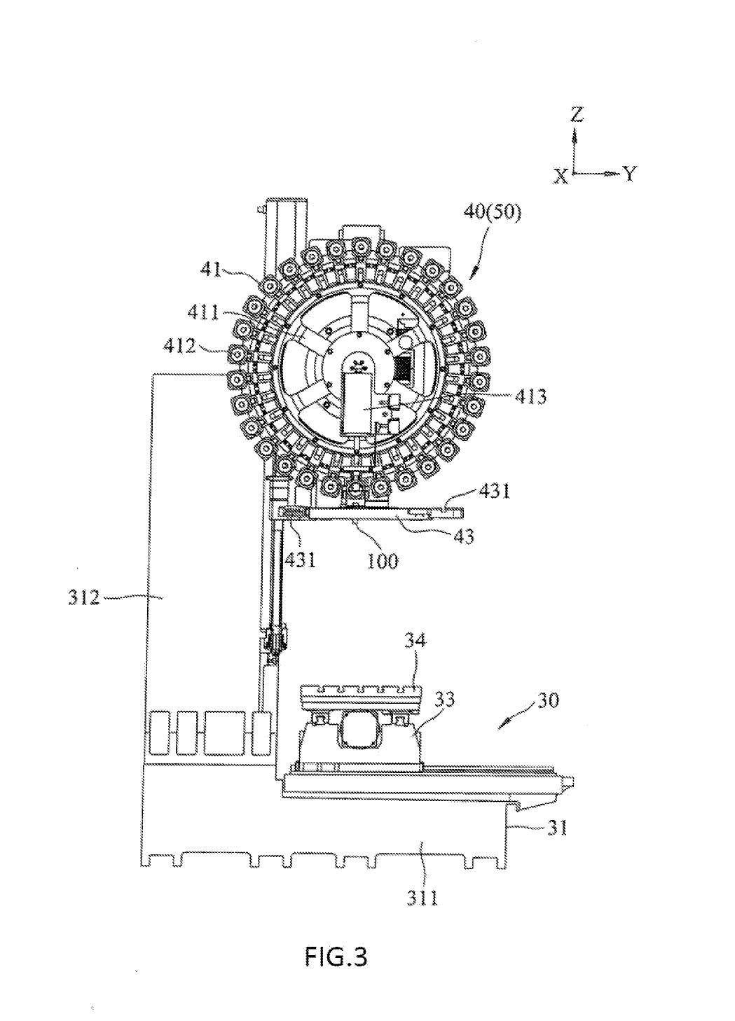

As shown in FIG. 2 and FIG. 3, according to the preferred embodiment of the present invention, a CNC machine tool with a single-spindle and two sets of cutting tool changers comprises a machine unit 30, a first cutting tool changer 40, and a second cutting tool changer 50. Below the preferred embodiment will be used to further explain and describe the functional and structural principles of the present invention.

The machine unit 30 comprises a machine body 31, a processing spindle head 32 movably arranged at the machine body 31, a saddle 33 movably arranged at the machine body 31, and a working table 34 movably arranged on the saddle 33. In addition, the machine body 31 comprises a base 311, a column 312 fixedly arranged at the rear end of the base 311, wherein the rear end of the processing spindle head 32 is slidingly attached on the column 312 and moves up and down (in the direction of the arrow Z), wherein a rotatable spindle 321 located at the bottom, front end of the processing spindle head 32 is able to store a cutting tool 100, wherein the saddle 33 slidingly arranged on a base 33 is able to move right and left (in the direction of the arrow X), and wherein the working table 14 is able to support workpieces. Furthermore, while the spindle 321 is rotating, the cutting tools 100 can be driven to rotate, based on the user instructions, and then the respective movement of the processing spindle head 32, the saddle 33, and the working table 34 are activated by the user instructions so that the cutting tool is adopted for cutting the workpiece.

The first cutting tool changer 40 comprises a first cutting tool magazine 41 arranged at a left side of the machine body 31, a first cam driving mechanism 42 arranged between the first cutting tool magazine 41 and the processing spindle head 32, and a first cutting tool exchanging arm 43 movably arranged on the first cam driving mechanism 42. Moreover, the first cutting magazine 41 comprises a rotating disk 411, multiple cutting tool cylinders 412, and a pushing-tool mechanism 413, wherein each of the cutting tools 100 is located inside each of the cutting tool cylinders 412. The rotating disk 411 is driven to rotate by the first cam driving mechanism 42, so that the cutting tool cylinders 412 with cutting tools 100 that is selected by the users rotates to the bottom exit of the first cutting tool magazine 21. Then, the pushing-tool mechanism 413 is adopted for pushing the cutting tool cylinders 412, so the cutting tools 100 extend and expose so as to facilitate exchanging. A cam and relative components are arranged inside the first cam driving mechanism 42, wherein the structure of the internal cam is well known technology and needs no further description. The first cutting tool exchanging arm 43 is arranged under the first cam driving mechanism 42, wherein the first cutting tool exchanging arm 43 is activated to move up and down and in a revolving motion by the internal cam. In addition, first two cutting tool holders 431 arranged on the two ends of the first cutting tool exchanging arm 43 are able to perform loosening and gripping motions.

The second cutting tool changer 50 comprises a second cutting tool magazine 51 arranged on a right side of the machine body 31, a second cam driving mechanism 52 arranged between the second cutting tool magazine 51 and the processing spindle head 32, a second cutting tool exchanging arm 53 movably arranged on the second cam driving mechanism 52, and second two cutting tool holders 531 arranged on the two ends of the second cutting tool exchanging arm 53, wherein multiple sets of cutting tools 100 are stored within the second cutting tool magazine 51, and wherein the second cutting tool exchanging arm 53 is activated to move up and down and in a revolving motion by the second cam driving mechanism 52.

Accordingly, since the structure of the first cutting tool changer 40 is the same as the structure of the second cutting tool changer 50, other components of the second cutting changer 50 will not be further described.

According to the above preferred embodiment of the present invention, the structural and functional principles of the CNC machine tool with a single-spindle and two sets of cutting tool magazines are illustrated. Below will further describe the cutting tool exchanging motion and effects produced by the preferred embodiment of the present invention.

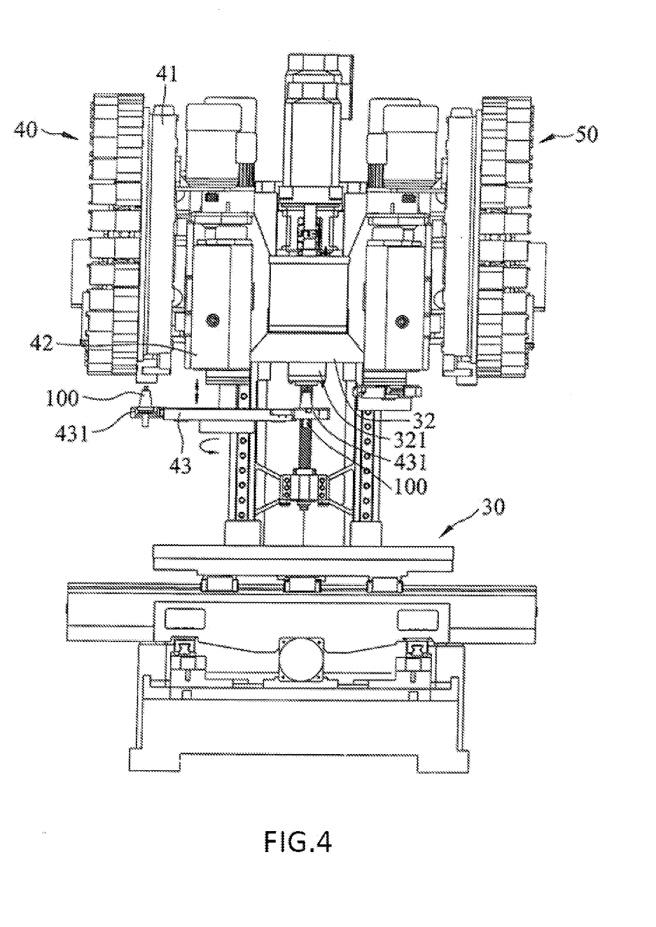

As shown in FIG. 4, when the spindle 321 is processing to exchange the cutting tools 100, it is able to select the first cutting tool exchanger 40 to process the cutting tool exchanging motion. Meanwhile, the first cutting magazine 41 starts to rotate the cutting tools 100 which are selected by the users to the bottom exit of the first cutting tool magazine 41. After that, the first cutting tool exchanging arm 43 is activated to revolve 180 degrees by the first cam driving mechanism 42 as the first two cutting tool holders 431 are respectively located on the positions of the spindle 321 and the bottom exit of the first cutting tool magazine 41, and then the first two cutting tool holders 431 are able to fixedly grip the cutting tools 1 located on the spindle 321 and the bottom exit of the first cutting tool magazine 41 respectively. Continuously, the first cutting tool exchanging arm 43 is activated to move downwardly by the first cam driving mechanism 42 so as to respectively detach the cutting tool 100 from the spindle 321 and from the first cutting tool magazine 41. Moreover, the first cutting tool exchanging arm 43 rotates 180 degrees, and then the position of the detached cutting tool 100 from the spindle 321 are exchanged to the position of the detached cutting tool 100 from the first cutting tool magazine 41.

Finally, the first cutting tool exchanging arm 43 is activated to move upwardly by the first cam driving mechanism 42, and then the detached cutting tool 100 from on the spindle 321 is loaded within the first cutting tool magazine 41 and the detached cutting tool 100 from the first cutting tool magazine 41 is loaded within the spindle 321. That is how the entire cutting tool exchanging motion finishes.

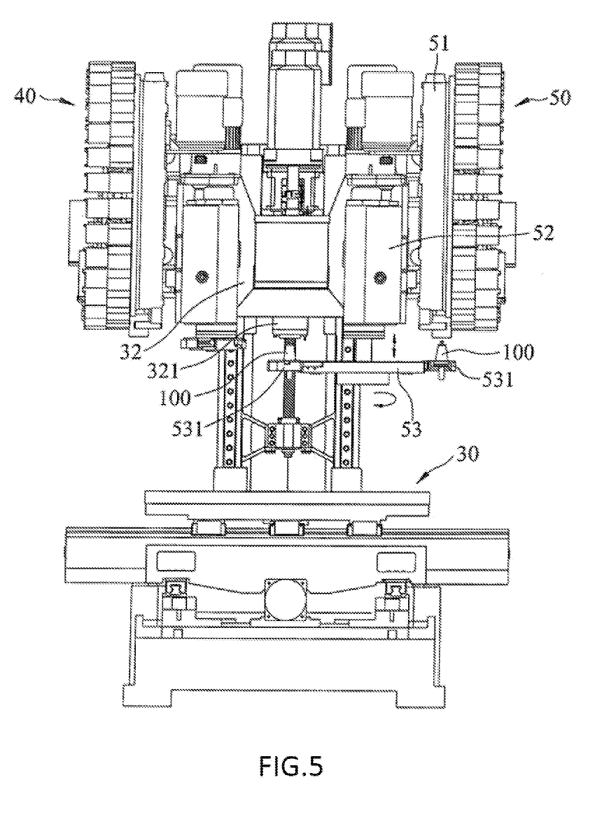

As shown in FIG. 5, when the spindle 321 is in the process of exchanging the cutting tools 100, it is able to select the second cutting tool exchanger 50 to process the cutting tool exchanging motion. Relatively, the first cutting tool unit stops working. Meanwhile, the second cutting magazine 51 starts to rotate the cutting tools 100 which are selected by the users to the bottom exit of the second cutting tool magazine 51. The second cutting tool exchanging arm 53 is activated to revolve 180 degrees by the second cam driving mechanism 52 as second two cutting tool holders 531 are respectively located on the positions of the spindle 321 and the bottom exit of the second cutting tool magazine 51, and then the second two cutting tool holders 531 are able to firmly grip the cutting tools 1 arranged on the spindle 321 and on the bottom exit of the second cutting tool magazine 51 respectively. Continuously, the second cutting tool exchanging arm 33 is activated to move downwardly by the second cam driving mechanism 52 so as to respectively detach the cutting tools 100 from the spindle 321 and from the second cutting tool magazine 51. After that, the second cutting tool exchanging arm 53 starts rotating 180 degrees, and then the position of detached cutting tool 100 from the spindle 321 is exchanged to the position of detached cutting tool 100 from the second cutting tool magazine 51. Finally, the second cutting tool exchanging arm 53 is activated to move upwardly by the second cam driving mechanism 52, and then detached cutting tools 100 from on the spindle 321 is loaded within the second cutting tool magazine 51 and detached cutting tools 100 from the second cutting tool magazine 51 is loaded within the spindle 321, The spindle 321 is then able to exchange the cutting tools 100 by the second cutting tools exchanging mechanism 50.

As has been described above, the CNC machine tool with a single-spindle and two sets of cutting tool changers provides a significantly improved production efficiency, and remedies the insufficient amounts of cutting tools, wherein the single-spindle has two sets of cutting tool magazines, the first cutting tool magazine 41 and the second cutting tool magazine 51. Thereby, two cutting tool magazines not only provide double amounts of cutting tools for use, but also provide diversified styles and sizes of cutting tools, in such a way that, it is able to facilitate and manage a huge number, multiple styles of cutting tools so as to deal with the cutting process for the complex-shaped work piece. Most importantly, two cutting tool magazines can be used interchangeably, and can provide sufficient amounts of cutting tools for the cutting process. In addition, it avoids overusing one of cutting tools 100, and extends the service life of that cutting tool 100. Moreover, each of cutting tools 100 from two sets of cutting tool magazines can be used interchangeably so as to minimize the abrasion loss of each cutting tool and efficiently maintain the precision of the cutting process. Even if the cutting tool 100 is put through lengthy operation and seriously abrades, that abraded cutting tool will need to be replaced. While one of the cutting tool magazines 41(51) can temporarily stop for replacement the other cutting tool magazine 51(41) can keep working. In such manner, when the abraded cutting tool is under replacement, the cutting process is continuous. In addition, there are two sets of cutting tool magazines 41(51) for interchangeable use, so overuse one of cutting tool magazines 41(51) may be avoided and thereby extend the life service time of two sets of cutting tool magazines 41(51). In the event that one of the cutting tool magazines 41(51) malfunctions, the users can immediately make an exchange to utilize the other cutting tool magazine 51(41), allowing for the malfunctioned cutting tool magazines to be repaired. Therefore, the CNC machine tool with a single-spindle and two sets of cutting tool changers doesn't need to shut down, and is suitable for long-term and non-stop operation so as to significantly improve the efficiency of production.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A CNC machine tool with a single-spindle and two sets of cutting tool changers, comprising a machine unit, a first cutting tool changer, and a second cutting tool changer ; wherein
said machine unit comprises a machine body, a processing spindle head arranged on said machine body, a working table movably provided on said machine body, and a spindle arranged within said processing spindle head and provided for installing cutting tools;
said first cutting tool changer comprises a first cutting tool magazine arranged on one side of said machine body adapted for storing large amount of said cutting tools, a first cam driving mechanism arranged between said first cutting tool magazine and said processing spindle head, and a first cutting tool exchanging arm movably arranged on said first cam driving mechanism, wherein said first cutting tool exchanging arm is activated to exchange said cutting tools respectively located within said first cutting magazine and located on said spindle by said first cam driving mechanism; and
said second cutting tool changer comprises a second cutting tool magazine arranged on the other side of said machine body adapted for storing large amount of said cutting tools, a second cam driving mechanism arranged between said second cutting tool magazine and said processing spindle head, and a second cutting tool exchanging arm movably arranged on said second cam driving mechanism, wherein said second cutting tool exchanging aim is activated to exchange said cutting tools respectively located within said second cutting magazine and located on said spindle by said second cam driving mechanism.

2. A CNC machine tool with a single-spindle and two sets of cutting tool changers, as recited in claim 1, wherein said machine body comprises a base and a column fixedly arranged on the rear end of said base, wherein said processing spindle head slidingly attached on said column can move up and down.

3. A CNC machine tool with a single-spindle and two sets of cutting tool changers, as recited in claim 2, wherein said machine body comprises a saddle movably arranged on said base for moving back and forth, wherein said working table slidingly arranged on said saddle for moving right and left.

4. A CNC machine tool with a single-spindle and two sets of cutting tool changers, as recited in claim 1, wherein said first cutting changer and said second cutting tool changer are respectively arranged on two sides of said processing spindle head.
